(19) United States
(12) Patent Application Publication
(10) Pub. No.: US 2015/0222769 A1
(43) Pub. Date: Aug. 6, 2015

(54) IMAGE FORMING APPARATUS, IMAGE FORMING SYSTEM, AND METHOD OF IMAGE FORMING

(71) Applicant: Hideki HINO, Kanagawa (JP)

(72) Inventor: Hideki HINO, Kanagawa (JP)

(21) Appl. No.: 14/614,028

(22) Filed: Feb. 4, 2015

(30) Foreign Application Priority Data
Feb. 5, 2014 (JP) 2014-020291
Jan. 15, 2015 (JP) 2015-005780

(51) Int. Cl. H04N 1/00

(52) U.S. Cl. CPC H04N 1/00477; H04N 1/00244; H04N 1/00411; H04N 2201/0094

(57) ABSTRACT

An image forming apparatus includes a display to display an input screen based on display-use information received from a server via a network; a hardware to conduct an image formation; a transmitter to transmit a condition setting and an execution instruction, input to the input screen, to the server; and a control unit to instruct the hardware to conduct an image formation based on execution instruction data when the image forming apparatus receives the execution instruction data generated by the server. The control unit reports the image formation to the server each time the image formation is conducted for a given image formation unit, and when screen information is transmitted to the image forming apparatus from the server as a response to the report when the image formation is being conducted, the control unit displays the screen information on the display.

### CROSS-REFERENCE TO RELATED APPLICATION

This application claims priority pursuant to 35 U.S.C. §119(a) to Japanese Patent Application Nos. 2014-020291, filed on Feb. 5, 2014 and 2015-005780, filed on Jan. 15, 2015 in the Japan Patent Office, the disclosure of which are incorporated by reference herein in their entirety.

### BACKGROUND

1. Technical Field

The present invention relates to an image forming apparatus, an image forming system, a method of image forming, and a storage medium of a program of the method of image forming.

2. Background Art

Various functions are demanded to multi-function peripherals (MFP) to meet various needs or demands of users, with which development period of time and cost of MFPs may increase. In view of this development issue, a remote system can be implemented, in which functions of the MFP can be provided by a server, disposed separately from the MFP, and the functions can be operated and executed using a control panel of the MFP. As to this remote system, for example, a user operates a Web browser on the MFP to access a Web server, and instructs the Web server to conduct data processing and data transfer, which is known as Web application technology.

### SUMMARY

In one aspect of the present invention, an image forming apparatus is devised. The image forming apparatus includes a display to display an input screen, through which condition setting input-able, based on display-use information received from a server via a network; a hardware to conduct an image formation; a transmitter to transmit a condition setting and an execution instruction, input to the input screen, to the server; and a control unit to instruct the hardware to conduct an image formation based on execution instruction data when the image forming apparatus receives the execution instruction data generated by the server based on the condition setting and the execution instruction transmitted by the transmitter. The control unit reports the image formation to the server each time the image formation is conducted for a given image formation unit, and when screen information is transmitted to the image forming apparatus from the server as a response to the report when the image formation is being conducted, the control unit displays the screen information on the display each time the response is received by the image forming apparatus.

In another aspect of the present invention, an image formation system is devised. The image formation system includes an image forming apparatus; and a server connectable with the image forming apparatus via a network. The image forming apparatus includes a display to display an input screen, through which condition setting input-able, based on display-use information received from the server via a network; a hardware to conduct an image formation; and a transmitter to transmit condition setting and execution instruction input to the input screen to the server. The server includes a receiver to receive the condition setting and the execution instruction transmitted from the transmitter of the image forming apparatus; a generator to generate execution instruction data based on the condition setting and the execution instruction; and a transmitter to transmit the execution instruction data to the image forming apparatus. The image forming apparatus includes a control unit to instruct the hardware to conduct an image formation based on the execution instruction data when the transmitted execution instruction data is received from the server. The control unit reports the image formation to the server each time the image formation is conducted for a given image formation unit, and when screen information is transmitted to the image forming apparatus from the server as a response to the report when the image formation is being conducted, the control unit displays the screen information on the display each time the response is received by the image forming apparatus.

In another aspect of the present invention, a method of forming an image by using an image forming apparatus having a hardware to conduct an image formation is devised. The method includes the steps of displaying an input screen, through which condition setting input-able, based on display-use information received from a server via a network; transmitting a condition setting and an execution instruction input to the input screen to the server; receiving execution instruction data generated by the server based on the condition setting and the execution instruction transmitted by the transmitting step; conducting an image formation using the hardware based on the execution instruction data; reporting the image formation to the server each time the image formation is conducted for a given image formation unit; and displaying screen information on the display when each time the screen information is transmitted from the server as a response to the reporting step when the image formation is being conducted.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is an overall configuration of an image forming system according to one or more example embodiments;

FIG. 2 is a schematic block diagram of a hardware of a remote server configuring the image forming system according to one or more example embodiments;

FIG. 3 is a functional block diagram of a remote server employed for the image forming system according to one or more example embodiments;

FIG. 4 is a hardware block diagram of MFP employed for the image forming system according to one or more example embodiments;

FIG. 5 is a functional block diagram of MFP configuring the image forming system according to one or more example embodiments.

FIGS. 6A and 6B are a sequence chart of signal flow when executing a copying operation by using the image forming system according to one or more example embodiments.

FIG. 7A is an example of information data table stored in a remote server;

FIGS. 7B and 7C are examples of display style of a control panel of MFP;

FIGS. 8A and 8B are examples of display style of a control panel of MFP of the image forming system according to one or more example embodiments when a copying operation is executed

FIGS. 9A and 9B illustrate a status of setting table stored in a memory of a remote server of the image forming system according to one or more example embodiments;

FIGS. 10A and 10B are examples of display style of a control panel of MFP of the image forming system according to one or more example embodiments when a copying operation is executed;

FIGS. 11A and 11B are a sequence chart of signal flow when executing a scan operation in the image forming system according to one or more example embodiments;

FIGS. 12A and 12B are examples of display style of a control panel of MFP of the image forming system according to one or more example embodiments when a scan operation is executed;

FIG. 13 is an examples of display style of a control panel of MFP of the image forming system according to one or more example embodiments when a scan operation is executed;

FIG. 14 is an example of status of a setting table stored in a memory of a remote server of the image forming system according to one or more example embodiments; and

FIG. 15 is a sequence chart of signal flow when an activation operation and a deactivation operation are executed in the image forming system according to one or more example embodiments.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, an apparatus or system according to an example embodiment is described hereinafter.

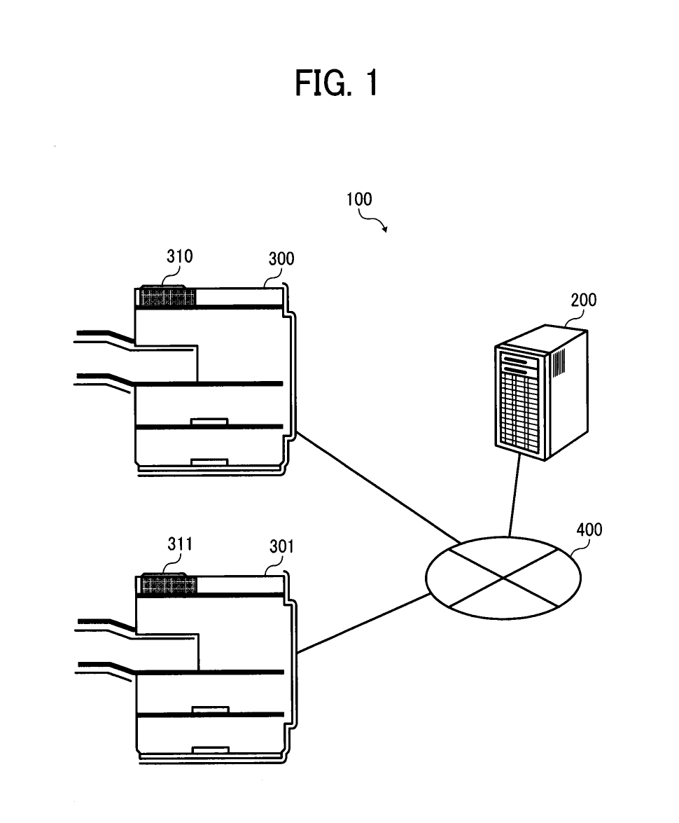

A description is given of a configuration of an image forming system according to one or more example embodiments. FIG. 1 is an overall configuration of an image forming system 100 according to one or more example embodiments.

As illustrated in FIG. 1, an image forming system 100 includes, for example, an image forming apparatus such as a printer, a multifunction peripheral (MFP) such as a MFP 300 and a MFP 301, and a server such as a remote server 200 that remotely controls the MFP 300 and MFP 301. The MFP 300 includes, for example, a control panel 310. The MFP 301 includes, for example, a control panel 311. The MFP 300 and MFP 301 can be connected to the remote server 200 via a network 400. In an example case of FIG. 1, the remote server 200 is connected to two MFPs 300 and 301 via the network 400, but not limited hereto. The remote server 200 can be connected to one or more MFPs depending on environment.

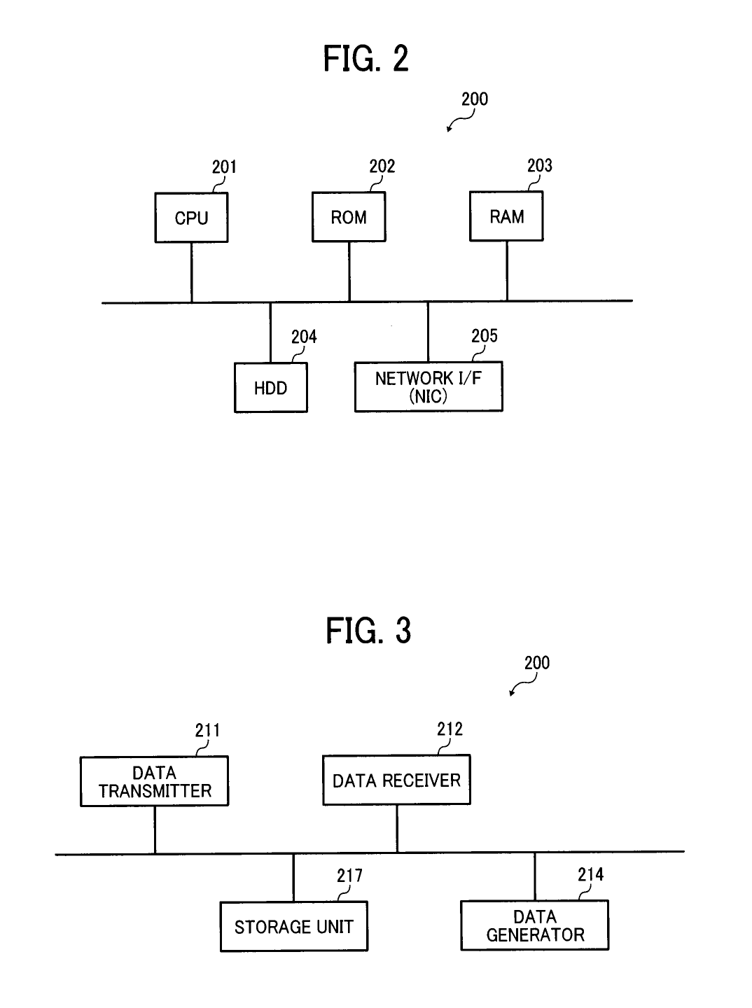

A description is given of a configuration of the remote server 200 configuring the image forming system 100. FIG. 2 is a schematic block diagram of a hardware of the remote server 200 configuring the image forming system 100.

The remote server 200, which is an example of servers, includes, a central processing unit (CPU) 201, a read only memory (ROM) 202, a random access memory (RAM) 203, a hard disk drive (HDD) 204, and a network interface (I/F) 205. The CPU 201, which is a control circuitry or a processor, is used as a controller that controls an overall operation of the remote server 200 such as an operation flow. The ROM 202 stores programs executable by the CPU 201 by loading programs. The RAM 203 stores data obtained by executing programs by using the CPU 201 temporally. The HDD 204 stores application programs executable by the CPU 201. The network interface (I/F) 205 is connected to the network 400 to conduct communication with the MFP 300 and MFP 301.

The HDD 204 stores information data table that correlates apparatus information and capabilities of apparatus because functions and displayable menus are different for each of the MFP 300 and MFP 301. This will be described later.

Further, the HDD 204 can maintain or store various data such as use-history information of the MFP 300 and MFP 301 when printing and copying are executed, and image data of display parts displayable on the control panels 310 and 311 of the MFP 300 and MFP 301. Further, the HDD 204 can maintain or store setting information of the MFP 300 and MFP 301, which may be retained in the MFP 300 and MFP 301, such as address data such as address list, counter data, and data of set values.

In a case of FIG. 2, the network I/F 205 is, for example, a network interface card (NIC). The network I/F 205 can be wired or wireless local area network (LAN), but the network I/F 205 can be other communication medium that can be connected to the MFP 300 and MFP 301 and can communicate information with the MFP 300 and MFP 301. For example, the network I/F 205 is, for example, Bluetooth (registered trademark), near field communication (NFC), universal serial bus (USB) or the like.

A description is now given of functions of the remote server 200 employed for the image forming system according to one or more example embodiments. FIG. 3 is a functional block diagram of the remote server 200 employed for the image forming system according to one or more example embodiments.

The remote server 200 includes, for example, a storage unit 217 that stores various data such as image data, language data, operation menu data in the HDD 204, wherein the various data is displayable on the control panels 310 and 311 of the MFP 300 and MFP 301. For example, the image data includes image data of buttons, apparatus images, and part images, the language data such as message data, and the operation menu data displayable on the controls 310 and 311.

The remote server 200 further includes, for example, a data generator 214, a data transmitter 211, and a data receiver 212. The data generator 214 updates and generates instruction data used for executing a process corresponding to an operation event received from a user by using the MFP, and data to be displayed when the MFP is executing a process.

The data transmitter 211 transmits set data correlating to apparatus information of MFP, data executed based on a notice or a command from the MFP, and data generated by the data generator 214 to the MFP. The data receiver 212 receives a command or instruction received by the MFP, and data indicating that a process at the MFP is completed.

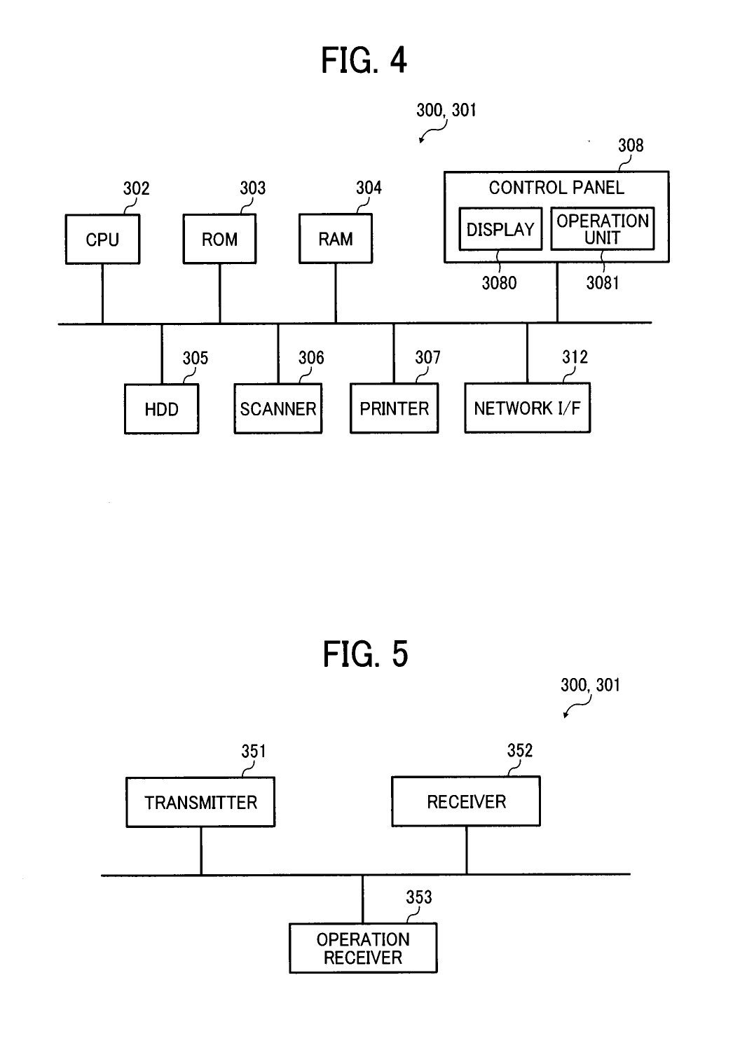

A description is now given of hardware configuration of MFP employed for the image forming system 100 according to one or more example embodiments. FIG. 4 is a hardware block diagram of MFP employed for the image forming system 100.

Each of the MFP 300 and MFP 301 includes a CPU 302, a ROM 303, a RAM 304, a HDD 305, a scanner 306, and a printer 307. The CPU 302, which is a control circuitry or a processor, is used as a controller or a control unit that controls an overall operation of the MFP 300 and MFP 301 such as an operation flow. The ROM 303 stores programs executable by the CPU 302 by loading programs. The RAM 304 stores data obtained by executing programs by using the CPU 302 temporally. The HDD 305 stores application programs executable by the CPU 302. The scanner 306 scans image data, and the printer 307 forms image data as an image.

Further, each of the MFP 300 and MFP 301 includes a control panel 308 that receives operations by a user. The control panel 308 includes, for example, a display 3080 and an operation unit 3081. The display 3080 is, for example, a liquid crystal display (LCD), and the operation unit 3081 is, for example, a hardware such as button keys. Further, the operation unit 3081 can be software keys disposed on a touch panel display of the display 3080. Further, each of the MFP 300 and MFP 301 includes a communication interface (I/F) 312 that receives data from the remote server 200.

Panel-display-use image data received via the communication I/F 312 is displayed on the display 3080 of the control panel 308. Specifically, based on display-use information such as panel-display-use image data received from the remote server 200, condition setting or the like can be input to remote server 200 using the operation unit 3081 or a touch panel such as the display 3080. The CPU 302 detects a command or instruction when the operation unit 3081 of the control panel 308 is operated. Further, the command or instruction received by the operation unit 3081 of the control panel 308 is transmitted to the remote server 200 via the communication I/F 312.

A description is given of functions of MFP configuring the image forming system 100 according to one or more example embodiments. FIG. 5 is a functional block diagram of MFP configuring the image forming system 100 according to one or more example embodiments.

Each of the MFP 300 and MFP 301 includes an operation receiver 353, a transmitter 351, and a receiver 352. The operation receiver 353 receives an operation by a user. The transmitter 351 transmits data corresponding to the received operation to the remote server 200. The receiver 352 receives data executed by the remote server 200.

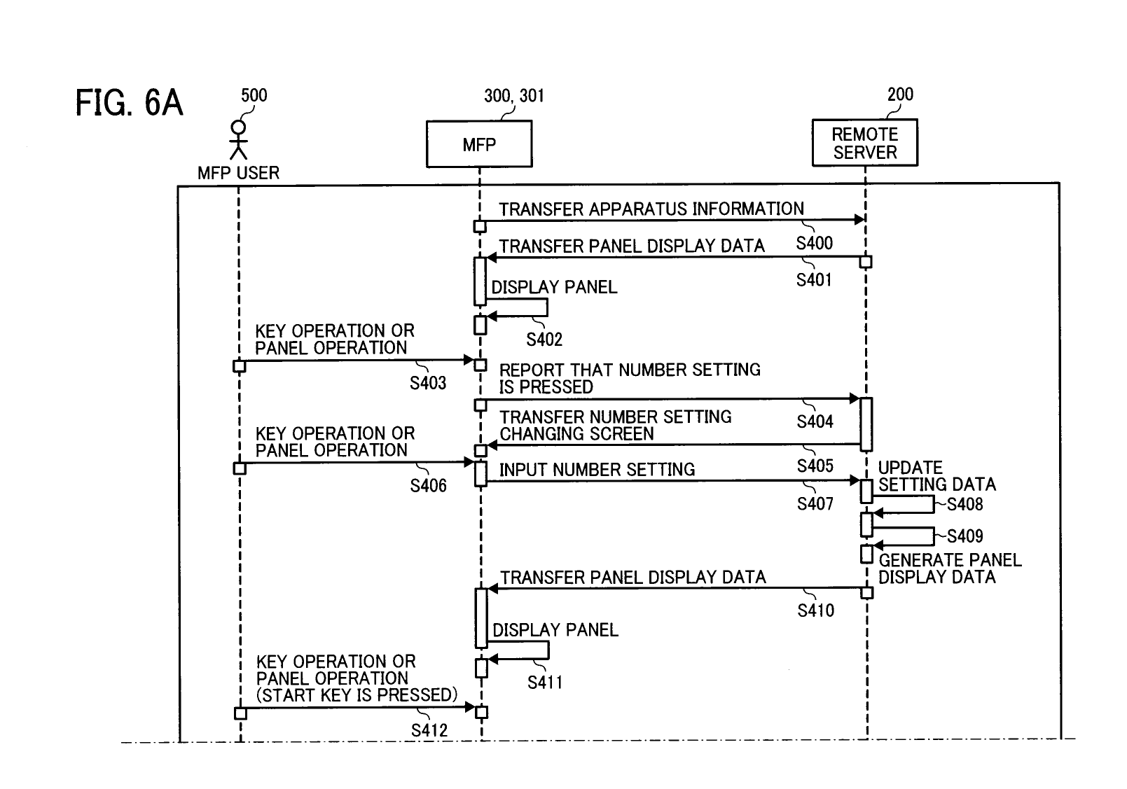

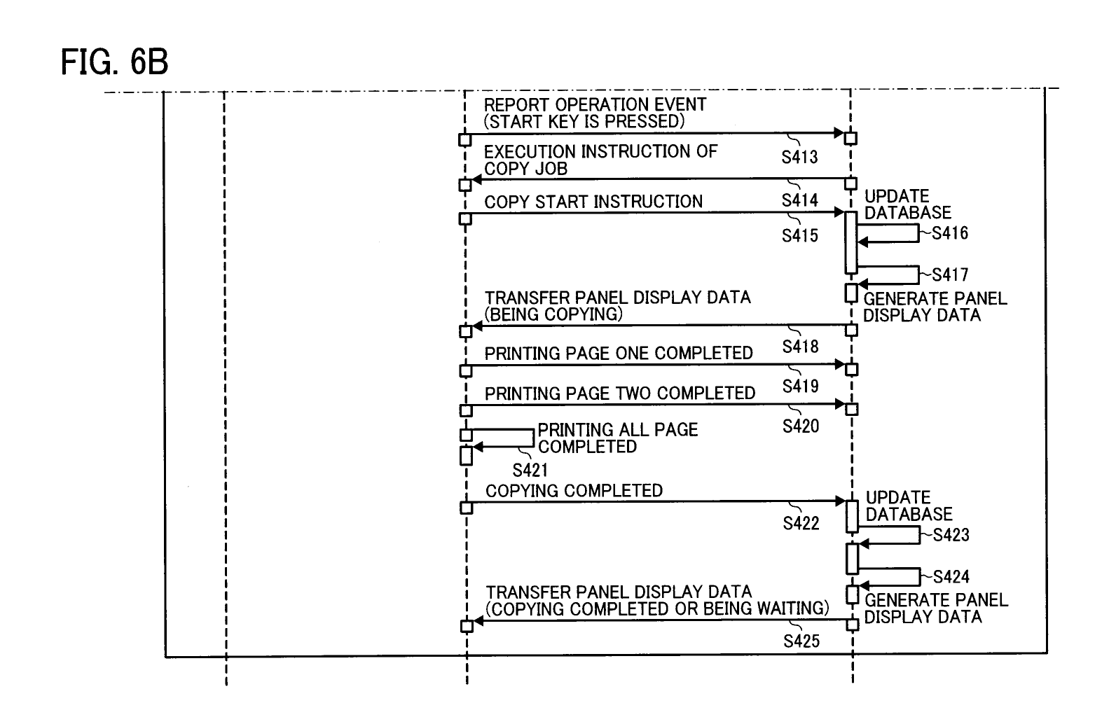

A description is given of signal flow when executing a copying operation by using the image forming system according to one or more example embodiments. FIG. 6 is a sequence chart of signal flow when executing a copying operation by using the image forming system according to one or more example embodiments.

As shown in FIG. 6, when a MFP user 50 conducts a copying operation, the MFP 300, MFP 301, and remote server 200 conduct following communications.

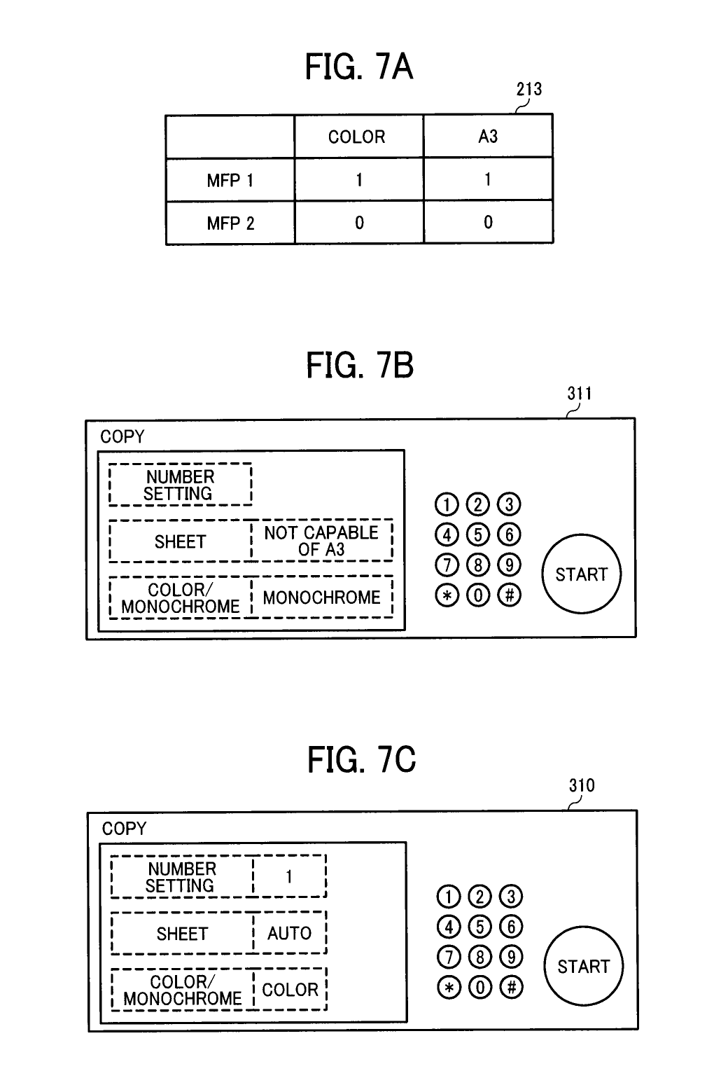

At first, the MFP 300 or MFP 301 transfers apparatus information to the remote server 200 (step S400). As described above, the HDD 204 of the remote server 200 stores information data table correlated apparatus information and capabilities of MFP for each type of MFPs, which is described with reference to FIG. 7. FIG. 7 illustrates an example information data table and examples of screen view of a control panel of a MFP of the image forming system according to one or more example embodiments when apparatus information is transferred. FIG. 7A is an example of information data table stored in the remote server 200, FIG. 7B is an example of display style of the control panel of the MFP, and FIG. 7C is another example of display style of the control panel of the MFP.

As illustrated in FIG. 7A, the HDD 204 of the remote server 200 stores an information data table 213 correlated types of MFPs and capabilities of the MFPs. As illustrated in FIG. 7A, the MFP 300 can conduct color printing, but the MFP 301 cannot conduct color printing. Further, the MFP 300 can use A3 size sheet, but the MFP 301 cannot use A3 size sheet.

Referring back to FIG. 6, the remote server 200 transfers panel display data, which is data used for displaying on a panel, to the MFP 300 and/or MFP 301 (S401). Panel-display-use image data can be panel-display-use bit map image data, or data defined by given formats such as extensible markup language (XML) or the like. In S400 and S401, for example, hypertext transfer protocol (HTTP) request is transmitted, and a response to the HTTP request is output, and S400 corresponds to the HTTP request, and S401 corresponds to the HTTP response, which is a response for the HTTP request.

For example, when the MFP is activated and a copy application execution is operated, the MFP accesses the remote server 200. Then, the remote server 200 transmits a response to the MFP. The MFP accesses the remote server 200 using, for example, a given uniformed resource locator (URL).

At step S400, if the MFP that transfers apparatus information to the remote server 200 is the MFP 301, the remote server 200 transfers panel display data shown in FIG. 7B, corresponding to information data table to the MFP 301 (S401). The panel display data of FIG. 7B indicates that A3 size sheet cannot be used (i.e., icon for selecting A3 is not displayed), and only monochrome printing can be used, which means selection of color and monochrome cannot be conducted.

Further, at step S400, if the MFP that transfers apparatus information to the remote server 200 is the MFP 300, the remote server 200 transfers panel display data shown in FIG. 7C, corresponding to information data table to the MFP 300 (S401). The panel display data of FIG. 7C indicates that number setting for printing is a default setting value such as 1, sheet size is automatically selected, and color/monochrome print setting is a default setting value such as color.

Each of the MFP 300 and MFP 301 displays panel display data transferred from the remote server 200 at S401 on the display 3080 of the control panel 308 (S402). The MFP user 50 conducts a key operation or a panel operation using the operation unit 3081 of the control panel 308 or the display 3080 of the touch panel of the MFP 300 (S403), and the MFP user 50 touches the number setting section in FIG. 7C to set the number of copies for printing, and then the MFP 300 reports that the number setting is pressed to the remote server 200 (S404).

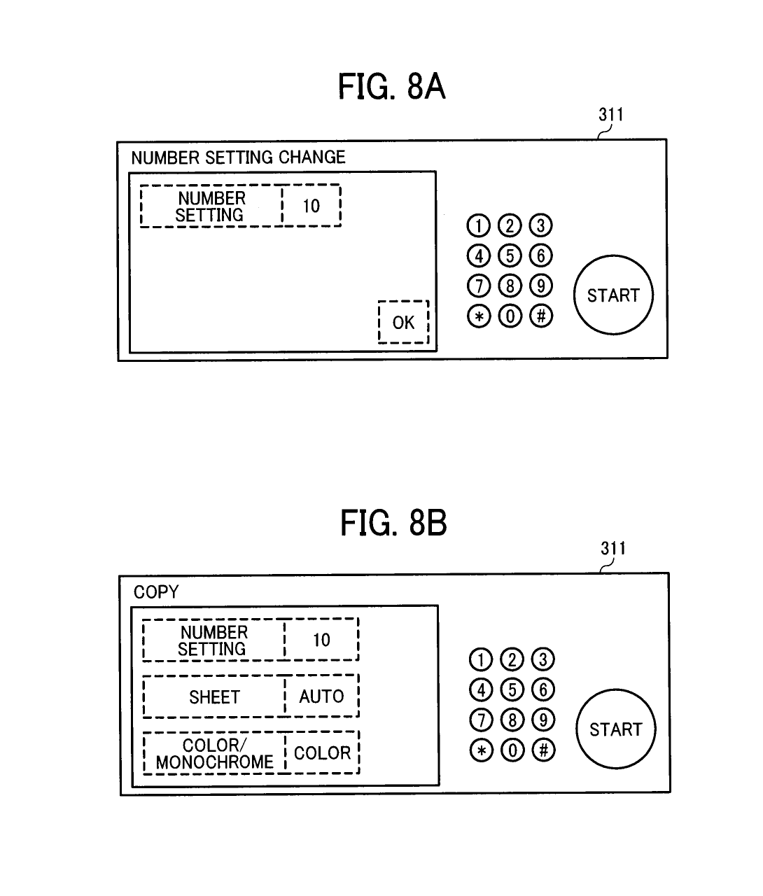

The remote server 200 transfers a number setting changing screen to the MFP 300 (S405). This number setting changing screen is described with reference to FIG. 8. FIG. 8 is an example of display style of the control panel of the MFP of the image forming system 100 according to one or more example embodiments when a copying operation is executed.

The MFP user 50 conducts a key operation or a panel operation on the number setting changing screen in FIG. 8A using the operation unit 3081 or the display 3080 of the touch panel (S406). For example, when 10 is set to the number setting, 10 is displayed in the number setting section as shown in FIG. 8A.

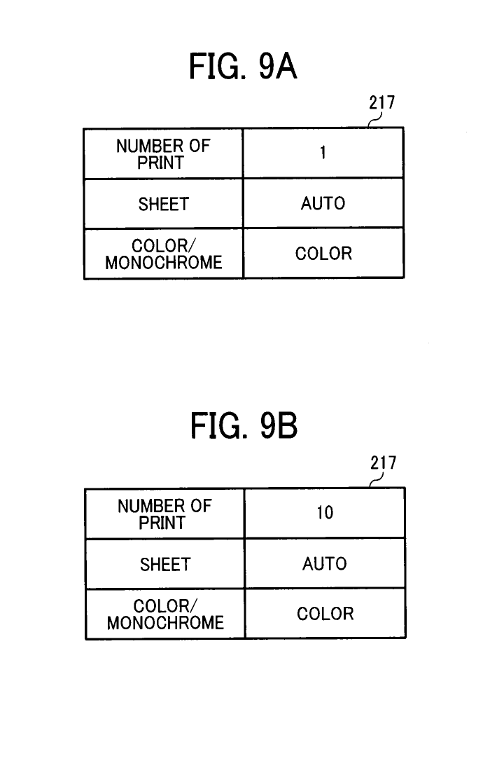

When the MFP user 50 presses an OK button on the operation unit 3081 or the display 3080 of the touch panel, the MFP 300 inputs the number setting to the remote server 200 (S407). The remote server 200 updates the number setting data from 1, which is the default setting value, to 10 (S408). A description is given of updating of data setting with reference to FIG. 9. FIG. 9 illustrates a status of setting table stored in a memory of the remote server 200 of the image forming system 100 according to one or more example embodiments.

As illustrated in FIG. 9A, the storage unit 217 of the remote server 200 stores default setting values for the number of print, sheet size, and color/monochrome printing as a setting table. When updating of the number setting data is conducted at S408, the storage unit 217 overwrites data of setting table of the storage unit 217 as shown in FIG. 9B, and stores the data of setting table, in which the number of print is changed from 1 to 10.

Then, the remote server 200 generates panel display data having changed the number setting to 10 as illustrated in FIG. 8B (S409), and transfers the panel display data to the MFP 300 (S410). Then, the MFP 300 displays panel display data shown in FIG. 8B on the display 3080 of the control panel 308 (S411).

Then, when the MFP user 50 presses a start key on the operation unit 3081 of the control panel 308 or the display 3080 of the touch panel (S412), the MFP 300 reports an operation event that the start key is pressed to the remote server 200 (S413). Then, the remote server 200 instructs the MFP 300 to execute a copy job (S414).

Execution instruction data of this copy job includes all setting values of the setting table stored in the storage unit 217 of the remote server 200. which means all setting values of the setting table such as number setting for print, sheet size, color/monochrome setting (print setting) shown in FIG. 9 are transmitted to the MFP 300. In this case, a protocol used as an instruction of the copy job execution can be a general protocol such as simple object access protocol (SOAP), representation state transfer (REST) or the like. Further, although FIG. 9 shows an example that setting values are stored for parameters such as the number of print, sheet size, and color/monochrome, but the parameters can be changed depending on types of MFPs.

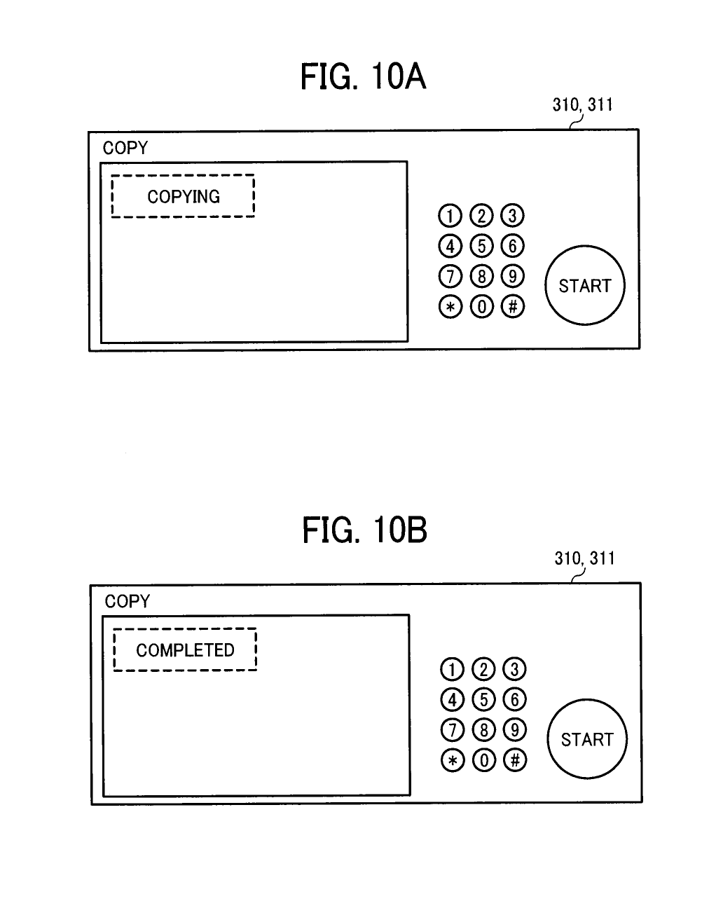

When a copy start instruction is transmitted from the MFP 300 (S415), the remote server 200 updates the database in the HDD 204 depending on a copy operation execution (S416), and generates panel display data that the copy operation execution is being conducted (S417). Then, the remote server 200 transmits the panel display data indicating the copying is being conducted to the MFP 300 (S418). A description is given of the panel display data with reference to FIG. 10. FIG. 10 is an example of display style of the control panel of the MFP of the image forming system according to one or more example embodiments when a copying operation is executed.

The panel display data indicating that the copying is being conducted, transmitted at S418, is displayed on the display 3080 of the control panel 308 as “copying” as illustrated in FIG. 1 OA. Then, the MFP 300 reports to the remote server 200 that printing is completed when the copying is executed by the scanner 306 and the printer 307 and a sheet is ejected (S419, S420). Specifically, MFP 300 reports the remote server 200 that copying is completed for a given image formation unit such as when copying of each one page is completed. When the copying is being conducted, screen information such as “copying” is transmitted to the MFP 300 from the remote server 200 as a response to the report, and the MFP 300 displays the screen information of “copying” on the display 3080 of the control panel 308 each time the response is received by the MFP 300.

When the final document printing is completed (S421), the MFP 300 reports to the remote server 200 that copying is completed (S422). Further, when the final document printing is not completed (i.e., error condition) at S421, an error message is displayed on the display 3080 of the control panel 308.

When the remote server 200 receives a notice or report that the copying is completed from the MFP 300 (S422), based on the notice, the remote server 200 updates print history information such as count-up of a counter on the database in the HDD 204 (S423). Then, the remote server 200 generates panel display data indicating that the copying is completed, or panel display data indicating that being in waiting (S424), and transfers the panel display data to the MFP 300 (S425). The panel display data indicating that the copying is completed, transferred at S425, is displayed on the display 3080 of the control panel 308 as “completed” as illustrated in FIG. 10B.

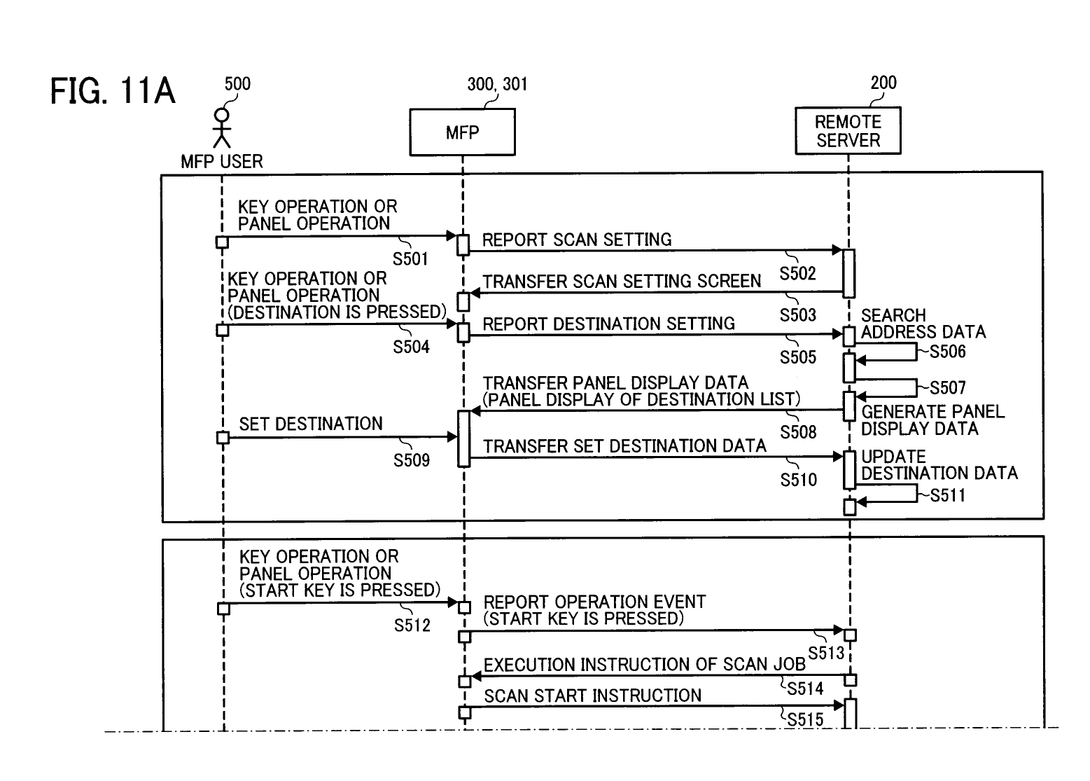

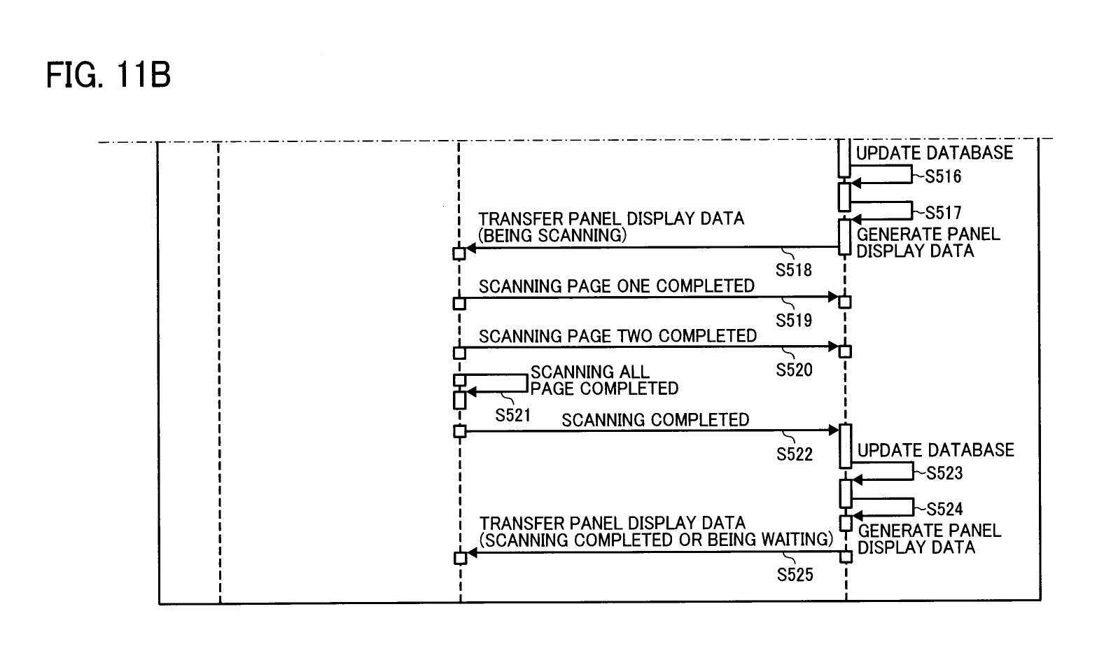

A description is given of signal flow when a scan operation is conducted in the image forming system 100 according to one or more example embodiments. FIG. 11 is a sequence chart of signal flow when executing a scan operation in the image forming system 100 according to one or more example embodiments.

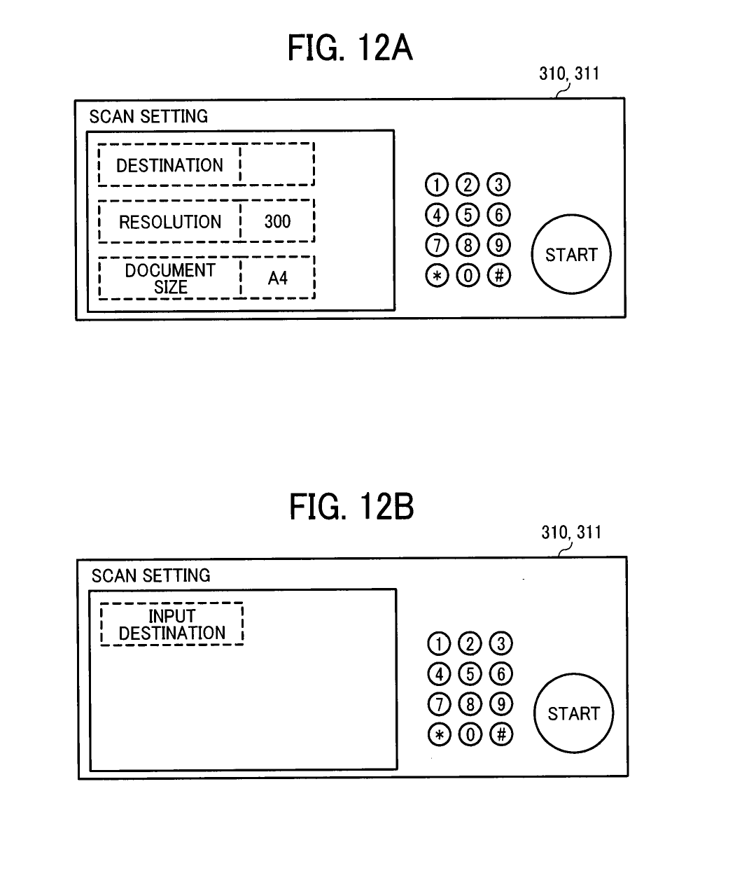

As illustrated in FIG. 11, when the MFP user 50 conducts a scan operation, the MFP 300, MFP 301, and remote server 200 conduct following communications. At first, a description is given of a destination selection operation for the scan operation. The MFP user 50 conducts a key operation or a panel operation using the operation unit 3081 of the control panel 308 or the display 3080 of the touch pane of the MFP 300 or the MFP 301 to select a destination (S501). Each of the MFP 300 and the MFP 301 transfers a scan setting notice to the remote server 200 (S502). The remote server 200 transfers the scan setting screen to the MFP 300 or the MFP 301 (S503). The scan setting screen is described with reference to FIG. 12.

FIG. 12 is an example of display style of the control panel of the MFP of the image forming system 100 according to one or more example embodiments when a scan operation is executed.

The scan setting screen shown in FIG. 12A is displayed on the display 3080 of the control panel 308 of the MFP 300 and the MFP 301. The MFP user 50 conducts a key operation or a panel operation using the operation unit 3081 of the control panel 308 or the display 3080 of the touch panel of the MFP 300 or the MFP 301 (S504), in which the MFP user 50 touches a destination section in FIG. 12A to set a destination. Then, the MFP 300 or the MFP 301 reports that a destination setting is pressed to the remote server 200 (S505).

The remote server 200 searches address data such as an address list stored in the HDD 204 (S506), and generates panel display data (S507). Then, the remote server 200 transfers panel display data to the MFP 300 or the MFP 301 (S508). A description is given of the panel display data transferred at S508.

As illustrated in FIG. 12B, the panel display data includes data for displaying a manual input screen to request the MFP user 50 to manually input a destination. In this case, the MFP user 50 conducts a key operation or a panel operation using the operation unit 3081 of the control panel 308 or the display 3080 of the touch panel to input a destination (S509).

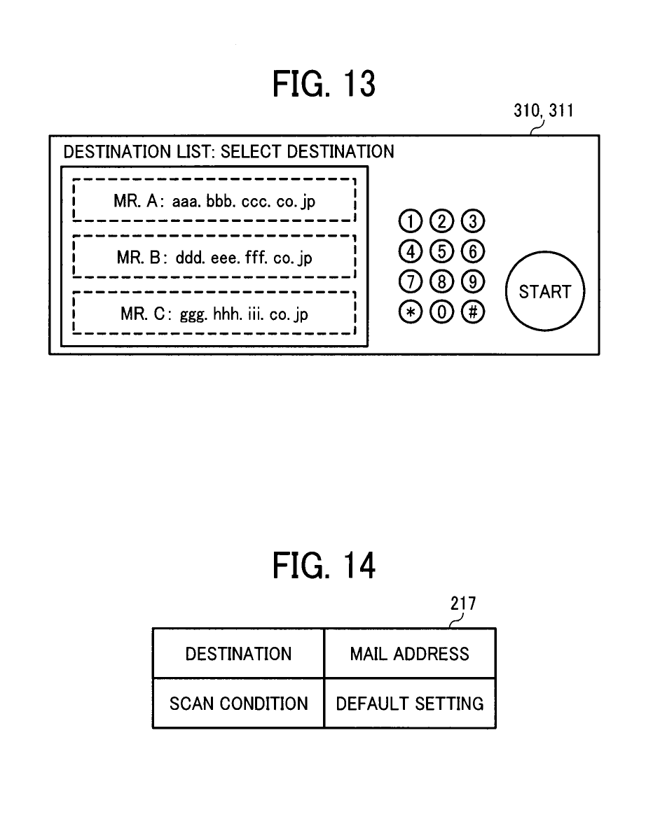

Further, as illustrated in FIG. 13, the panel display data includes data for displaying a selective input screen that displays a destination list and requests the MFP user 50 to select a destination from the destination list. FIG. 13 is an example of display style of the control panel of the MFP of the image forming system 100 according to one or more example embodiments when a scan operation is executed, in which the MFP user 50 conducts a key operation or a panel operation using the operation unit 3081 of the control panel 308 or the display 3080 of the touch panel to select a destination (S509).

The storage unit 217 of the remote server 200 stores default setting values for each of destination and scan condition as setting table as illustrated in FIG. 14. FIG. 14 is an example of status of the setting table stored in a memory of the remote server 200 of the image forming system according to one or more example embodiments.

When the MFP user 50 inputs or selects a destination at S509, the MFP 300 or the MFP 301 transfers the input or selected destination data to the remote server 200 (S510). The remote server 200 updates data of setting table of FIG. 14 based on the transferred data (S511).

The destination section in FIG. 14 can be input with a destination by the MFP user 50 manually or can be input with a destination by selecting Mr. A, Mr. B, Mr. C from the displayed destination list of FIG. 13, in which a mail address of the destination is input. Further, since the scan condition of FIG. 14 is set to the default setting value, the resolution level of, for example, 300 dpi (dots per inch) is input. Further, similar to the setting table for copying described with reference to FIG. 9, the data and parameters of the setting table of FIG. 14 can be changed depending on setting conditions and types of MFPs.

A description is now given of a scan execution operation for the scan operation. Communication when the scan operation is executed can be devised similar to the communication when the copying operation is executed, which corresponds to S412 to S425 of FIG. 6.

The MFP user 50 presses a start key on the operation unit 3081 of the control panel 308 or the display 3080 of the touch panel (S512). The MFP 300 or the MFP 301 reports an operation event that the start key is pressed to the remote server 200 (S513). Then, the remote server 200 instructs the MFP 300 or the MFP 301 to execute a scan job (S514).

Execution instruction data of the scan job includes all setting values of the setting table stored in the storage unit 217 of the remote server 200. which means all setting values of the setting table such as destination setting, scan condition shown in FIG. 14 are transmitted to the MFP 300 and the MFP 301. In this case, a protocol used as an instruction of the scan job execution can be a general protocol similar to the copy job execution.

When a scan start instruction is transmitted from the MFP 300 or the MFP 301 (S515), the remote server 200 updates the database in the HDD 204 depending on the scan operation execution (S516). Then, the remote server 200 generates panel display data indicating that the scan operation is being executed (S517). Then, the remote server 200 transmits the panel display data indicating that the scan operation is being executed to the MFP 300 or the MFP 301 (S518). This panel display data is similar to the panel display data described with the display style of the control panel of FIG. 10 when the copying operation is executed.

The panel display data indicating that scan operation is being executed, transmitted at S518, is displayed on the display 3080 of the control panel 308 as “scanning.” Then, the MFP 300 or the MFP 301 executes the scanning using the scanner 306, and reports to the remote server 200 that scanning is completed when the scanning is completed each time (S519, S520). Specifically, MFP 300 reports the remote server 200 that scanning is completed for a given image formation unit such as when scanning of each one page is completed. When the scanning is being conducted, screen information such as “scanning” is transmitted to the MFP 300 from the remote server 200 as a response to the report, and the MFP 300 displays the screen information of “scanning” on the display 3080 of the control panel 308 each time the response is received by the MFP 300.

At step S521, when the final document scanning is completed (S521), the MFP 300 or the MFP 301 transmits scan data to a mail address of the destination set as shown in FIG. 14. Further, the MFP 300 or the MFP 301 reports that the scanning is completed to the remote server 200 (S522). Further, when the final document scanning is not completed (i.e., error condition) at S521, an error message is displayed on the display 3080 of the control panel 308.

When the remote server 200 receives a notice or report that the scanning is completed from the MFP 300 or the MFP 301 (S522), based on the notice, the remote server 200 updates scanning history information such as count-up of a counter on the database in the HDD 204 (S523).

Then, the remote server 200 generates panel display data indicating that the scanning is completed, or panel display data indicating that being in waiting (S524), and transfers the panel display data to the MFP 300 or the MFP 301 (S525). The panel display data indicating that the scanning is completed, transferred at S525, is displayed on the display 3080 of the control panel 308 as “completed” similar to the panel display data indicating that the copying is completed as illustrated in FIG. 10B.

In the above described example embodiments, it is devised that the MFP 300 or the MFP 301 displays a display image on the display 3080 of the control panel 308 when the MFP 300 or the MFP 301 receives the panel display data from the remote server 200, and further devised that the MFP 300 or the MFP 301 reports a key operation by the MFP user 50 to the remote server 200. With this configuration, an operation flow is not required to be installed in the MFP 300 or the MFP 301, and thereby added functions can be devised by adding the functions only to the remote server 200.

Further, in the above described example embodiments, since information of setting values such as address data such as address list, and history information is not required to be retained at the MFP, the MFP does not require a hardware to store information of setting values, with which the development cost and time of the MFP can be reduced. Further, the MFP user 50 can recognize a status of current processing being executed by the remote server 200 with real time, and thereby convenience of the MFP user 50 can be enhanced.

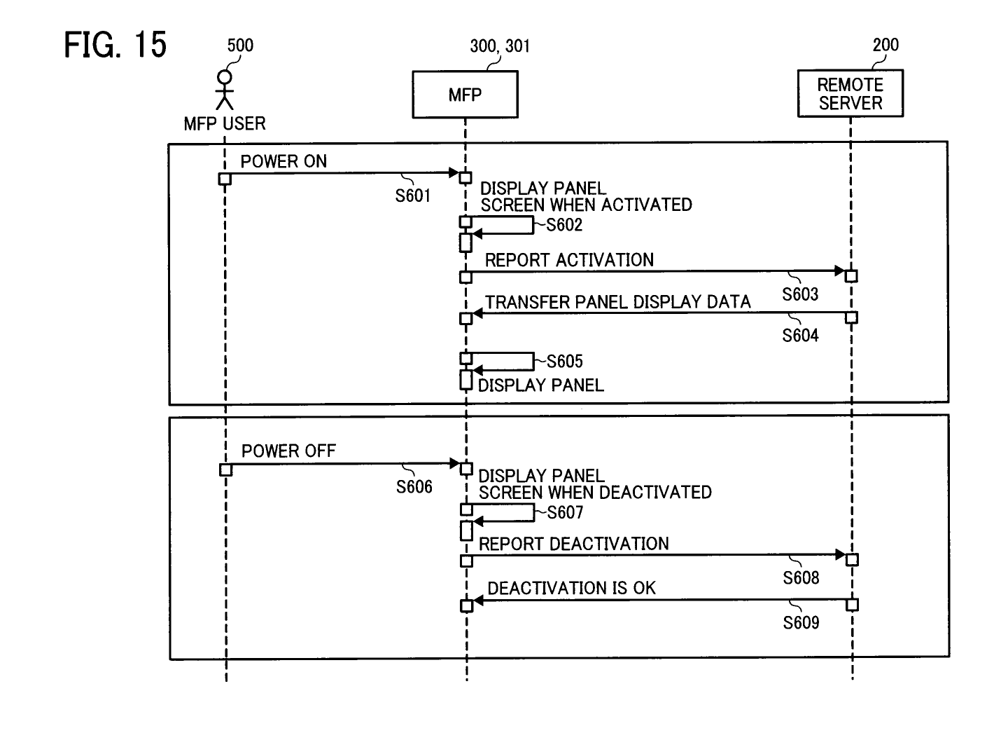

A description is given of signal flow when an activation operation and a deactivation operation are executed in the image forming system 100 according to one or more example embodiments. FIG. 15 is a sequence chart of signal flow when the activation operation and the deactivation operation are executed in the image forming system 100 according to one or more example embodiments.

A description is given of communication between the MFP 300 or the MFP 301 and the remote server 200 when the activation operation and the deactivation operation are executed with reference to FIG. 15. The MFP user 50 turns a power switch ON (S601). The MFP 300 or the MFP 301 displays a panel image for activation stored in the HDD 305 on the display 3080 of the control panel 308 (S602). Then, the MFP 300 or the MFP 301 reports that the MFP is activated to the remote server 200 with apparatus information such as type information (S603).

When the remote server 200 receives an activation notice from the MFP, the remote server 200 loads information data table, described with reference to FIG. 7A, correlating apparatus information and capabilities of MFPs for each type, stored in the HDD 204, on the ROM 202 and/or the RAM 203. Then, the CPU 201 controls an operation flow using the loaded data.

Further, when the MFP user 50 turns the power switch OFF (S606), the MFP 300 or the MFP 301 displays a panel image for deactivation stored in the HDD 305 on the display 3080 of the control panel 308 (S607). Then, the MFP 300 or the MFP 301 reports that the MFP is deactivated to the remote server 200 with apparatus information such as type information (S608).

The data of panel image when activating the MFP can use data stored in the HDD 305 of the MFP 300 or the MFP 301, and this data of panel image when activating the MFP can be transmitted from the remote server 200 when the MFP is deactivated.

Specifically, when the MFP 300 or the MFP 301 reports a deactivation of the MFP to the remote server 200 (S608), and receives a notice or report of deactivation OK from the remote server 200 (S609), the MFP 300 or the MFP 301 receives and stores the data of panel image when activating the MFP for the next time activation. Then, when activating the MFP for the next time, the stored data of panel image is displayed. Further, the data of panel image for the next time activation of the MFP can be transmitted from the remote server 200 when the remote server 200 receives an activation notice and returns a response (S604), and can be stored in the MFP 300 or the MFP 301.

In the above described example embodiments, displaying of screen on the control panel and function-adding processing for the MFP can be conducted at the remote server 200. Therefore, even if a function is added, it is not required develop a new function and an operation flow for the MFP, with which development cost and time of the MFP can be reduced, and further functions can be added flexibly.

Further, the operations of each functional block for the image forming system 100 according to one or more example embodiments described with FIGS. 6, 11, and 15 can be executed by programs executed by one or more computers. Specifically, the CPU 201 of the remote server 200 loads programs stored in the ROM 202, and the CPU 302 of the MFP 300 and MFP 301 loads programs stored in the ROM 303, and then each step of the programs are sequentially executed.

In the above described example embodiments for the image forming apparatus, the image forming system, the method of image forming, and the programs of method of image forming, setting information can be set to the image forming apparatus with real time, with which user's convenience can be enhanced.

The present invention can be implemented in any convenient form, for example using dedicated hardware, or a mixture of dedicated hardware and software. Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

Numerous additional modifications and variations for the image forming apparatus, the image forming system, and the control method, a program to execute the control method by a computer, and a storage or carrier medium of the program are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended

What is claimed is:

1. An image forming apparatus, comprising:
a display to display an input screen, through which condition setting input-able, based on display-use information received from a server via a network;
a hardware to conduct an image formation;
a transmitter to transmit a condition setting and an execution instruction, input to the input screen, to the server; and
a control unit to instruct the hardware to conduct an image formation based on execution instruction data when the image forming apparatus receives the execution instruction data generated by the server based on the condition setting and the execution instruction transmitted by the transmitter,
wherein the control unit reports the image formation to the server each time the image formation is conducted for a given image formation unit, and
wherein when screen information is transmitted to the image forming apparatus from the server as a response to the report when the image formation is being conducted, the control unit displays the screen information on the display each time the response is received by the image forming apparatus.

2. The image forming apparatus of claim 1, wherein when the image forming apparatus receives the execution instruction data, the image forming apparatus transmits an instruction to start the image formation to the server,
the server generates screen information indicating the image formation is being conducted based on the instruction received from the image forming apparatus, and then the image forming apparatus receives the screen information from the server.

3. The image forming apparatus of claim 1, wherein when the image forming apparatus transmits an instruction indicating the image formation is completed to the server, the server generates screen information indicating that the image formation is completed based on the instruction, and then the image forming apparatus receives the screen information from the server.

4. The image forming apparatus of claim 1, wherein the condition setting includes one or more parameters, and the one or more parameters is changeable depending on types of apparatus.

5. An image formation system comprising:
an image forming apparatus; and
a server connectable with the image forming apparatus via a network,
wherein the image forming apparatus including:
a display to display an input screen, through which condition setting input-able, based on display-use information received from the server via a network;
a hardware to conduct an image formation; and
a transmitter to transmit condition setting and execution instruction input to the input screen to the server; and
wherein the server including:
a receiver to receive the condition setting and the execution instruction transmitted from the transmitter of the image forming apparatus;
a generator to generate execution instruction data based on the condition setting and the execution instruction; and
a transmitter to transmit the execution instruction data to the image forming apparatus,
wherein the image forming apparatus including:
a control unit to instruct the hardware to conduct an image formation based on the execution instruction data when the transmitted execution instruction data is received from the server,
wherein the control unit reports the image formation to the server each time the image formation is conducted for a given image formation unit, and
wherein when screen information is transmitted to the image forming apparatus from the server as a response to the report when the image formation is being conducted, the control unit displays the screen information on the display each time the response is received by the image forming apparatus.

6. A method of forming an image by using an image forming apparatus having a hardware to conduct an image formation, the method comprising the steps of;
displaying an input screen, through which condition setting input-able, based on display-use information received from a server via a network;
transmitting a condition setting and an execution instruction input to the input screen to the server;
receiving execution instruction data generated by the server based on the condition setting and the execution instruction transmitted by the transmitting step;
conducting an image formation using the hardware based on the execution instruction data;
reporting the image formation to the server each time the image formation is conducted for a given image formation unit; and
displaying screen information on the display when each time the screen information is transmitted from the server as a response to the reporting step when the image formation is being conducted.
